(19) United States
(12) Patent Application Publication
(10) Pub. No.: US 2021/0065144 A1
(43) Pub. Date: Mar. 4, 2021

(54) Payment Control Device, Payment System, and Control Program for Payment Control Device

(71) Applicant: Infcurion Group, Inc., Chiyoda-ku, Tokyo (JP)

(72) Inventor: Hiroki Maruyama, Chiyoda-ku, Tokyo (JP)

(21) Appl. No.: 16/961,024

(22) PCT Filed: Jan. 31, 2019
(86) PCT No.: PCT/JP2019/003439

§ 371 Date: Jul. 9, 2020

(30) Foreign Application Priority Data
Mar. 12, 2018 (JP) 2018-044073

(51) Int. Cl. G06Q 20/10; G06Q 40/02; G06Q 20/40; G06Q 20/02; G06Q 20/32; G06K 7/10; G06K 7/14

(52) U.S. Cl. CPC G06Q 20/108; G06Q 40/02; G06Q 20/4037; G06K 7/1417; G06Q 20/02; G06Q 20/3276; G06K 7/1095; G06Q 20/405

(57) ABSTRACT

A server as the payment control device includes an acquisition unit, a determination unit, an instruction unit, and a storage unit. The acquisition unit acquires transaction information including store information, amount information, and customer account information from a transmission source of the transaction information. The determination unit checks a customer account status corresponding to the customer account information, and determines whether or not to establish a transaction between a customer and a store based on the amount information and the customer account status. In the case of determining to establish the transaction by the determination unit, the storage unit accumulates and stores transaction information related to the established transaction. The instruction unit instructs a financial institution system to withdraw a transaction amount indicated as the amount information in the transaction information accumulated in the storage unit from the account of the customer based on an instruction of the customer.

### CROSS-REFERENCE TO RELATED APPLICATION(S)

This application is a 371 national stage application of PCT/JP2019/003439, filed on Jan. 31, 2019, which claims priority to Japanese Patent Application No. 2018-044073 filed on Mar. 12, 2018, the entire disclosure of which is hereby incorporated by reference.

### TECHNICAL FIELD

The present invention relates to a payment control device, a payment system, and a control program for the payment control device.

### BACKGROUND

Conventionally, convenient payment methods that do not use cash, such as credit payment using a credit card or the like and debit payment using a debit card, etc., have been known as payment methods for the purchase of products or the like.

In credit payment, transaction information of a customer for a certain period from a closing date to a next closing date is accumulated within a predetermined credit line in a system such as a credit card company or the like, and the total amount of the accumulated transaction is withdrawn from a bank account of the customer on a predetermined withdrawal date. However, due to a long period from a date of purchase of a product or the like to a withdrawal date and a difficulty of understanding a concept of the closing date, it has been pointed out that credit payment causes problems such as overuse and difficulty in asset management.

On the other hand, in debit payment, a transaction amount is immediately withdrawn from a bank account when a transaction is performed in a store. For this reason, debit payment is less likely to cause an overuse problem when compared to credit payment, and makes asset management relatively easy. However, since the transaction amount is immediately withdrawn from the bank account, debit payment may cause other withdrawals such as mortgage loans or the like to unexpectedly fail due to insufficient account balance. For this reason, the customer using the debit payment needs to be aware of the account balance in advance, and there is a problem that the effort of the customer to check the account balance increases. In addition, there is another problem that the use of debit payment is hindered by giving up the use of debit payment in consideration of other withdrawals of the customer.

With regard to the above-described problem, JP 2001-351036 A discloses a technology in which a customer changes a withdrawal date of debit payment.

### SUMMARY

However, in the technology described in JP 2001-351036 A, a shipping date of a product of a sales company is changed so that a bank, the sales company, and the like are prevented from taking a risk of reimbursement due to the change of the withdrawal date of debit payment. That is, the technology described in JP 2001-351036 A simply delays the timing of the transaction. For this reason, when the customer changes the withdrawal date, the customer may not obtain the product at the desired timing, which is inconvenient.

The invention has been made in view of the above circumstances, and an object of the invention is to provide a payment control device, a payment system, and a control program for the payment control device that provide a payment method having high customer convenience.

A payment control device according to an embodiment of the invention which achieves the object includes an acquisition unit that acquires transaction information including store information corresponding to identification information of a store with which a customer performs a transaction, amount information corresponding to information about a transaction amount in the transaction, and customer account information corresponding to information about an account of the customer in a financial institution from a transmission source of the transaction information, a determination unit that checks a customer account status which is a status of the account of the customer corresponding to the customer account information acquired by the acquisition unit, determines to establish the transaction between the customer and the store when the transaction amount is equal to or less than a predetermined amount calculated based on the customer account status, and determines not to establish the transaction when the transaction amount exceeds the predetermined amount, a storage unit that accumulates and stores the transaction information related to the established transaction when it is determined to establish the transaction by the determination unit, and an instruction unit that instructs a financial institution system corresponding to a system installed in the financial institution to withdraw the transaction amount indicated as the amount information in the transaction information accumulated in the storage unit from the account of the customer based on an instruction of the customer.

In addition, a payment system according to an embodiment of the invention which achieves the object includes the payment control device, a store terminal corresponding to a terminal installed in the store, a customer terminal corresponding to a terminal owned by the customer, and the financial institution system corresponding to a system installed in the financial institution.

In addition, a control program of the payment control device according to an embodiment of the invention which achieves the object is a control program of a payment control device that controls a payment between a customer and a store, the control program for causing a computer to execute processing including an acquisition step of acquiring transaction information including store information corresponding to identification information of the store with which the customer performs a transaction, amount information corresponding to information about a transaction amount in the transaction, and customer account information corresponding to information about an account of the customer in a financial institution from a transmission source of the transaction information, a determination step of checking a customer account status which is a status of the account of the customer corresponding to the customer account information acquired in the acquisition step, determining to establish the transaction between the customer and the store when the transaction amount is equal to or less than a predetermined amount calculated based on the customer account status, and determining not to establish the transaction when the transaction amount exceeds the predetermined amount, a storage step of accumulating and storing the transaction information related to the established transaction when it is determined to establish the transaction in the determination step, and an instruction step of instructing a financial institution system corresponding to a system installed in the financial institution to withdraw the transaction amount indicated as the amount information in the transaction information accumulated in the storage step from the account of the customer based on an instruction of the customer.

According to the payment control device according to an embodiment of the invention, it is determined whether or not to establish a transaction between the customer and the store based on the amount information and the customer account status. Then, in the case of determining to establish the transaction, the payment control device accumulates and stores transaction information related to the transaction to be established. Thereafter, the payment control device instructs the financial institution system to withdraw the transaction amount from the account of customer based on the instruction of the customer. In this way, the payment control device can control the financial institution system so as to withdraw the transaction amount at a timing after the transaction desired by the customer, and it is possible to provide a payment method having high customer convenience.

### BRIEF DESCRIPTION OF THE DRAWINGS

FIG. 1 is a diagram illustrating a schematic configuration of a payment system according to an embodiment of the invention;

FIG. 2 is a block diagram illustrating a schematic configuration of a store terminal;

FIG. 3 is a block diagram illustrating a schematic configuration of a customer terminal;

FIG. 4 is a block diagram illustrating a schematic configuration of a server;

FIG. 5 is a block diagram illustrating a schematic configuration of a controller of the serve;

FIG. 6 is a block diagram illustrating a schematic configuration of a financial institution system;

FIG. 7 is a sequence chart illustrating a procedure of a tanking process of the payment system;

FIG. 8 is a sequence chart illustrating a procedure of a withdrawal process of the payment system;

FIG. 9A is a diagram illustrating an example of a display screen on the customer terminal;

FIG. 9B is a diagram illustrating an example of a display screen on the customer terminal;

FIG. 9C is a diagram illustrating an example of a display screen on the customer terminal; and

FIG. 10 is a sequence chart illustrating a procedure of a tanking process of a payment system according to a second embodiment.

### DETAILED DESCRIPTION

Hereinafter, embodiments of the invention will be described with reference to the accompanying drawings. In the description of the drawings, the same elements will be denoted by the same reference symbols, and redundant description will be omitted. In addition, dimensional ratios in the drawings are exaggerated for convenience of description and may be different from actual ratios.

### Payment System

First, a payment system according to an embodiment of the invention will be described.

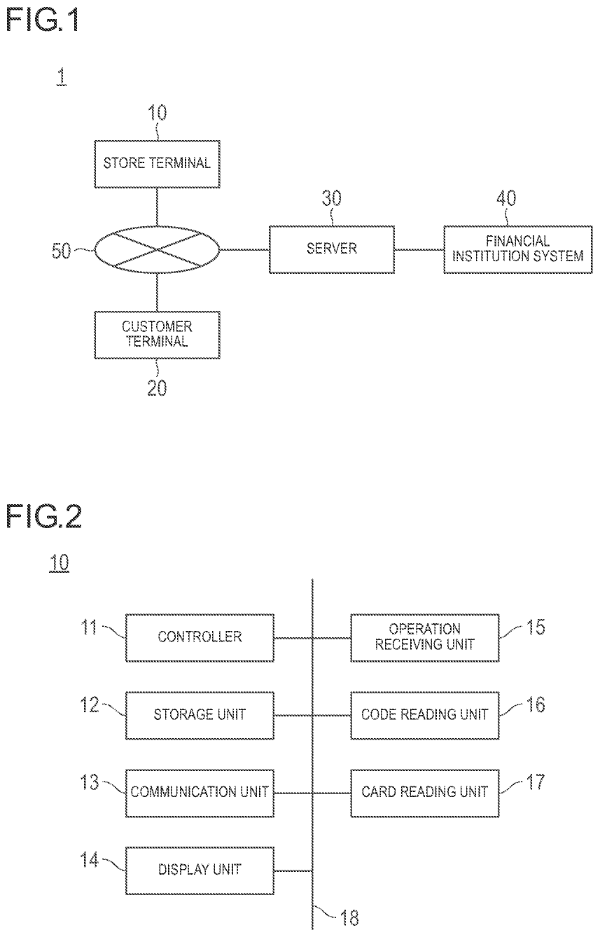

FIG. 1 is a diagram illustrating a schematic configuration of the payment system according to the embodiment of the invention.

As illustrated in FIG. 1, a payment system 1 includes a store terminal 10, a customer terminal 20, a server 30, and a financial institution system 40. The store terminal 10, the customer terminal 20, and the server 30 are communicably connected to each other via a network 50 such as the Internet. Further, the server 30 and the financial institution system 40 are also communicably connected to each other.

For example, the store terminal 10 is a terminal such as a PC (Personal Computer), or the like installed in a store as a member store that uses the payment system 1.

The customer terminal 20 is a terminal owned by a customer who uses the payment system 1. For example, the customer terminal 20 may correspond to a portable terminal such as a mobile phone, a smartphone, a tablet terminal, and the like carried by a customer, or a terminal such as a PC, and the like.

The server 30 as a payment control device is a device that controls a transaction between the store and the customer, payment in the financial institution system 40, and the like.

The financial institution system 40 is a system installed in a financial institution such as a bank or the like.

Next, details of each configuration will be described.

### Store Terminal

FIG. 2 is a block diagram illustrating a schematic configuration of the store terminal.

As illustrated in FIG. 2, the store terminal 10 includes a controller 11, a storage unit 12, a communication unit 13, a display unit 14, an operation receiving unit 15, a code reading unit 16, and a card reading unit 17. The respective components are communicably connected to each other via a bus 18.

The controller 11 is a CPU (Central Processing Unit), which controls the respective components and executes various arithmetic processes according to a program.

The storage unit 12 includes a ROM (Read Only Memory) that stores various programs and various data in advance, a RAM (Random Access Memory) that temporarily stores programs and data as a work area, a hard disk that stores various programs and various data, and the like.

The communication unit 13 is an interface for communicating with another terminal or device via the network 50. For example, the communication unit 13 transmits and receives various data or the like to and from the server 30 or the like.

The display unit 14 includes a liquid crystal display, a touch panel, and the like, and displays various types of information. The operation receiving unit 15 includes a pointing device such as a mouse, a keyboard, a touch panel, and the like, and receives various operations of a user. Note that the display unit 14 and the operation receiving unit 15 may be integrally configured by a touch panel or the like.

The code reading unit 16 is a reading device such as a bar code reader, a QR code reader, and the like that read a one-dimensional code such as a bar code, a two-dimensional code such as a QR code (registered trademark) or the like. For example, the code reading unit 16 reads a bar code attached to a product, a service, and the like (hereinafter, a “product” or the like) to cause the controller 11 to acquire information about a transaction amount of the product or the like (hereinafter, “amount information”).

The card reading unit 17 is a reading device such as a card reader or the like that reads information contained in a card. For example, the card reading unit 17 reads a card such as a debit card owned by the customer to cause the controller 11 to acquire information about an account of the customer at a financial institution in which the financial institution system 40 is installed (hereinafter, “customer account information”) associated with the card. The customer account information includes, for example, information about an account number of the customer.

### Customer Terminal

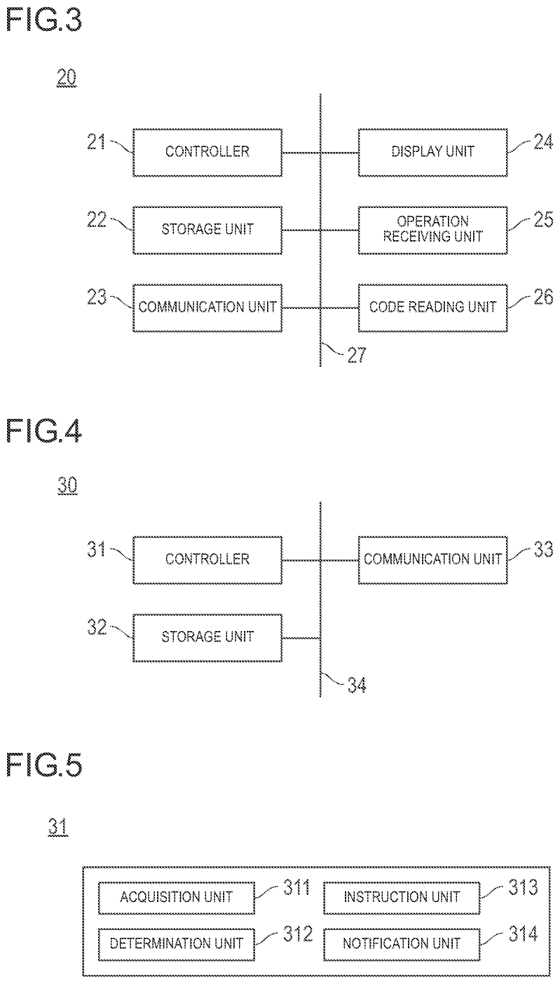

FIG. 3 is a block diagram illustrating a schematic configuration of the customer terminal.

As illustrated in FIG. 3, the customer terminal 20 includes a controller 21, a storage unit 22, a communication unit 23, a display unit 24, an operation receiving unit 25, and a code reading unit 26. The respective components are communicably connected to each other via a bus 27. Note that each component of the customer terminal 20 has a similar function to that of each component of the store terminal 10, and thus a description will be omitted. In addition, for example, the code reading unit 26 may include an imaging unit such as a camera provided in the customer terminal 20, an image analysis unit that analyzes an image of a bar code, a QR code (registered trademark), and the like captured by the imaging unit to extract information or the like.

### Server

FIG. 4 is a block diagram illustrating a schematic configuration of the server. FIG. 5 is a block diagram illustrating a schematic configuration of a controller of the server.

As illustrated in FIG. 4, the server 30 includes a controller 31, a storage unit 32, and a communication unit 33. The respective components are communicably connected to each other via a bus 34. Note that each component of the server 30 has a similar function to that of each component of the store terminal 10, and thus a detailed description will be omitted.

The controller 31 reads a program to execute processing, thereby functioning as an acquisition unit 311, a determination unit 312, an instruction unit 313, and a notification unit 314 as illustrated in FIG. 5. The acquisition unit 311 acquires various types of information from the store terminal 10, the customer terminal 20, and the financial institution system 40 via the communication unit 33 or the like. The determination unit 312 determines whether or not to establish a transaction between the store and the customer. The instruction unit 313 issues a predetermined instruction to the financial institution system 40 via the communication unit 33 or the like. The notification unit 314 gives a predetermined notification to the store terminal 10 and the customer terminal 20 via the communication unit 33 or the like.

### Financial Institution System

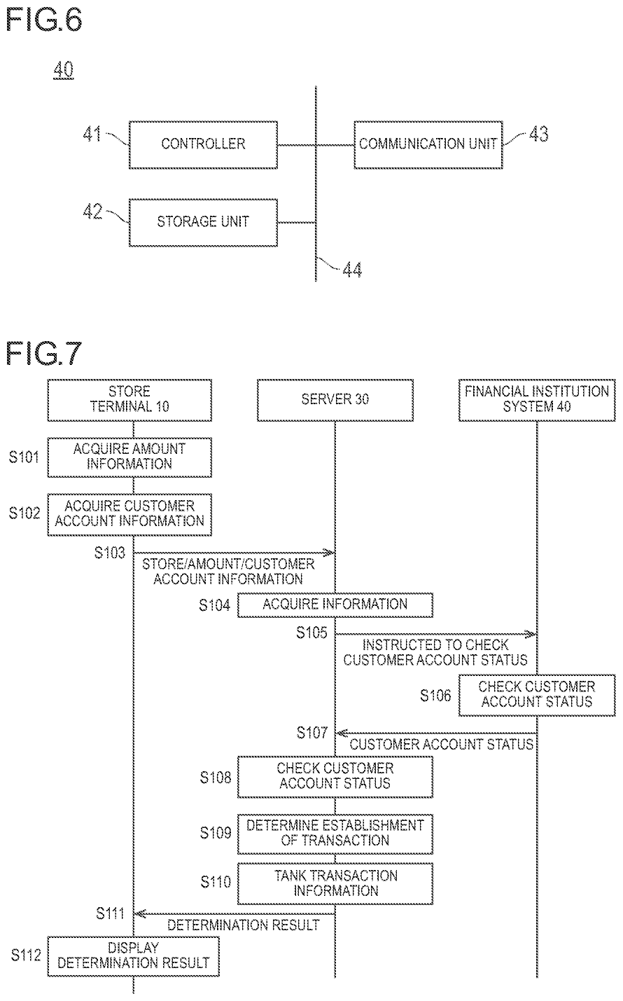

FIG. 6 is a block diagram illustrating a schematic configuration of the financial institution system.

As illustrated in FIG. 6, the financial institution system 40 includes a controller 41, a storage unit 42, and a communication unit 43. The respective components are communicably connected to each other via a bus 44. Each component of the financial institution system 40 has a similar function to that of each component of the store terminal 10, and thus a detailed description will be omitted. The storage unit 42 functions as a database that stores a plurality of accounts including accounts of the customer and the store using the payment system 1, and the controller 41 controls transfer of funds in the accounts of the customer and the store stored in the storage unit 42 and establishes payment.

Note that the payment system 1 may include, for example, a device other than the store terminal 10, the customer terminal 20, the server 30, and the financial institution system 40. In addition, each of the store terminal 10, the customer terminal 20, the server 30, and the financial institution system 40 may include components other than the above components, or may not include some of the above components.

### First Embodiment

Hereinafter, a flow of processing of the payment system 1 according to a first embodiment of the invention will be described. Processing of the payment system 1 performs a control operation to provide a payment method having high customer convenience. Hereinafter, first, a tanking process in the payment system 1 will be described, and then a withdrawal process in the payment system 1 will be described.

FIG. 7 is a sequence chart illustrating a procedure of the tanking process of the payment system. The tanking process illustrated in FIG. 7 is executed among the store terminal 10, the server 30, and the financial institution system 40. That is, an algorithm of the tanking process illustrated in FIG. 7 is stored as a program in each storage unit of the store terminal 10, the server 30, and the financial institution system 40, and is executed by each controller.

First, the store terminal 10 is operated by a clerk or the like, thereby acquiring amount information of a product or the like intended to be purchased by the customer (step S101). For example, the store terminal 10 acquires the amount information by reading a bar code attached to the product or the like intended to be purchased by the customer using the code reading unit 16. When the customer intends to purchase a plurality of products or the like, the store terminal 10 may acquire a total value of the transaction amounts of all the products or the like as the amount information.

Subsequently, the store terminal 10 acquires customer account information associated with a card owned by the customer by being operated by the clerk or the like (step S102). For example, the store terminal 10 acquires the customer account information by reading a debit card owned by the customer using the card reading unit 17.

Subsequently, the store terminal 10 transmits, to the server 30, transaction information including identification information of the store in which the store terminal 10 is installed (hereinafter “store information”), and the amount information and the customer account information acquired in steps S101 and S102 (step S103). The store information may correspond to identification information of the store where the customer performs transaction.

Subsequently, the server 30 acquires the transaction information transmitted in step S103 (step S104). Then, the server 30 instructs the financial institution system 40 to transmit the customer account information included in the transaction information acquired in step S104 and check a status of the account of the customer corresponding to the customer account information (hereinafter “customer account status”) (step S105).

Subsequently, the financial institution system 40 checks the customer account status based on the customer account information transmitted in step S105 in accordance with the instruction of the server 30 in step S105 (step S106). For example, the financial institution system 40 checks a status of a balance of a savings account of the customer at the financial institution as the customer account status. Alternatively, the financial institution system 40 may check, as the customer account status, a status of at least one of a balance of a savings account of the customer, a balance of a time deposit account, an overdraft limit of an overdraft or the like, an available amount of a loan, and the like at the financial institution. Note that an item of the customer account status checked by the financial institution system 40 in step S106 may be arbitrarily settable in the server 30. Then, the financial institution system 40 notifies the server 30 of the customer account status checked in step S106 (step S107).

Subsequently, the server 30 checks the customer account status notified in step S107 (step S108). Then, the server 30 determines whether or not to establish a transaction between the customer and the store based on the amount information acquired in step S104 and the customer account status checked in step S107 (step S109).

For example, when a current status of the balance of the savings account is checked as the customer account status in step S108, the server 30 determines whether or not the transaction amount indicated by the amount information is equal to or less than the current balance of the savings account in step S109. Then, when the transaction amount is equal to or less than the balance of the savings account, the server 30 determines to establish transaction between the customer and the store. On the other hand, when the transaction amount exceeds the balance of the savings account, the server 30 determines not to establish transaction, and ends processing. When withdrawal from the savings account is scheduled, the server 30 may check a status of a balance of the savings account after the withdrawal as the customer account status rather than the current status of the balance of the savings account in step S108. Then, in step S109, the server 30 may determine whether or not to establish transaction between the customer and the store by determining whether or not the transaction amount is equal to or less than the balance of the savings account after the withdrawal.

Alternatively, for example, when a current status of the balance of the time deposit account is checked as the customer account status in step S108, the server 30 may determine whether or not the transaction amount is equal to or less than the current balance of the time deposit account in step S109. Then, when the transaction amount is equal to or less than the balance of the time deposit account, the server 30 may determine to establish transaction between the customer and the store. When the transaction amount exceeds the balance of the time deposit account, the server 30 may determine not to establish the transaction and end processing.

Alternatively, for example, when a current status of the overdraft limit of the overdraft or the like is checked as the customer account status in step S108, the server 30 may determine whether or not the transaction amount is equal to or less than the overdraft limit in step S109. Then, when the transaction amount is equal to or less than the overdraft limit, the server 30 may determine to establish transaction between the customer and the store. When the transaction amount exceeds the overdraft limit, the server 30 may determine not to establish the transaction and end processing.

Alternatively, for example, when a current status of the available amount of the loan is checked as the customer account status in step S108, the server 30 may determine whether or not the transaction amount is equal to or less than the available amount of the loan in step S109. Then, when the transaction amount is equal to or less than the available amount of the loan, the server 30 may determine to establish transaction between the customer and the store. When the transaction amount exceeds the available amount of the loan, the server 30 may determine not to establish the transaction and end processing.

Further, in step S108, for example, the server 30 may check two or more statuses among the statuses of the balance of the savings account, the balance of the time deposit account, the overdraft limit of the overdraft or the like, the available amount of the loan, and the like. In this case, when the transaction amount satisfies a predetermined condition based on any one of the statuses, the server 30 may determine to establish transaction between the customer and the store. That is, for example, in the case of checking the statuses of the balance of the savings account and the balance of the time deposit account in step S108, the server 30 may determine whether or not the transaction amount is equal to or less than the balance of the savings account or equal to or less than the balance of the time deposit account. Then, even in a case where the transaction amount exceeds the balance of the savings account, the server 30 may determine to establish the transaction when the transaction amount is equal to or less than the balance of the time deposit account.

In addition, the server 30 may calculate an upper limit value of the amount establishing transaction between the customer and the store as a threshold based on the status of at least one of the balance of the savings account, the balance of the time deposit account, the overdraft limit of the overdraft or the like, the available amount of the loan, and the like. Then, when the transaction amount is equal to or less than the threshold, the server 30 may determine to establish transaction between the customer and the store. When the transaction amount exceeds the threshold, the server 30 may determine not to establish the transaction.

Alternatively, the server 30 may calculate an upper limit of an accumulated value of the amount that establishes transaction within a predetermined period as a threshold, and determine whether or not the accumulated amount of transaction established within the predetermined period is equal to or less than the threshold, thereby determining whether or not to establish each transaction. The server 30 may calculate the upper limit of the accumulated value as a threshold based on the status of at least one of the balance of the savings account, the balance of the time deposit account, the overdraft limit of the overdraft or the like, the available amount of the loan, and the like. Note that the server 30 may be able to set an arbitrary value as an upper limit value of a single transaction amount or an upper limit value of the accumulated transaction amount as described above.

Subsequently, in the case of determining to establish the transaction in step S109, the server 30 accumulates and stores transaction information related to the established transaction in the storage unit 32, thereby performing tanking (step S110). That is, in the present embodiment, instead of immediately instructing the financial institution system 40 to perform withdrawal to complete the payment between the customer and the store, the server 30 tanks the transaction information. For example, the server 30 may tank the transaction information acquired in step S104 together with acquired date information for each transaction.

Subsequently, the server 30 notifies the store terminal 10 of a determination result in step S109 (step S111). Note that processing of steps S110 and S111 may be executed simultaneously, or may be executed in a changed order.

Subsequently, the store terminal 10 displays the determination result notified in step S111 on the display unit 14 (step S112). In this way, the customer and the store can check the determination result. When the server 30 determines to establish the transaction, the store can provide the customer with the product or the like and complete the transaction at the store. Then, the payment system 1 ends the tanking process.

Next, a description will be given of the withdrawal process in the payment system 1.

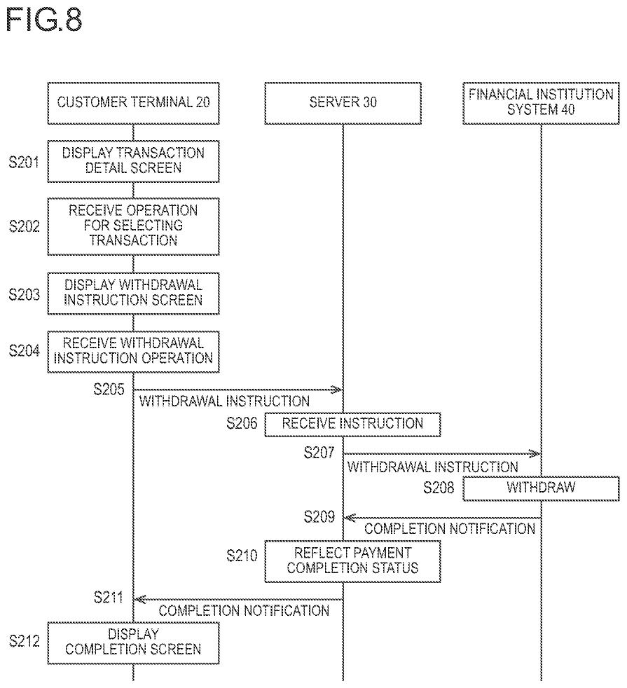

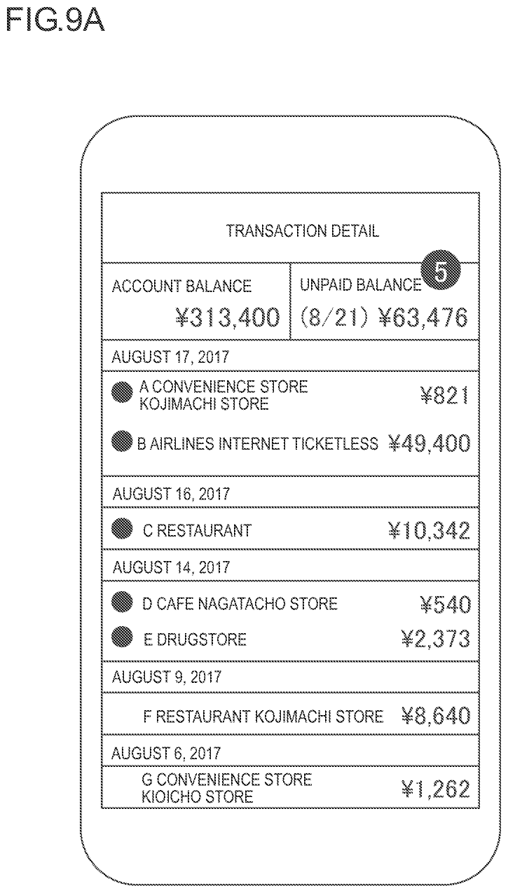

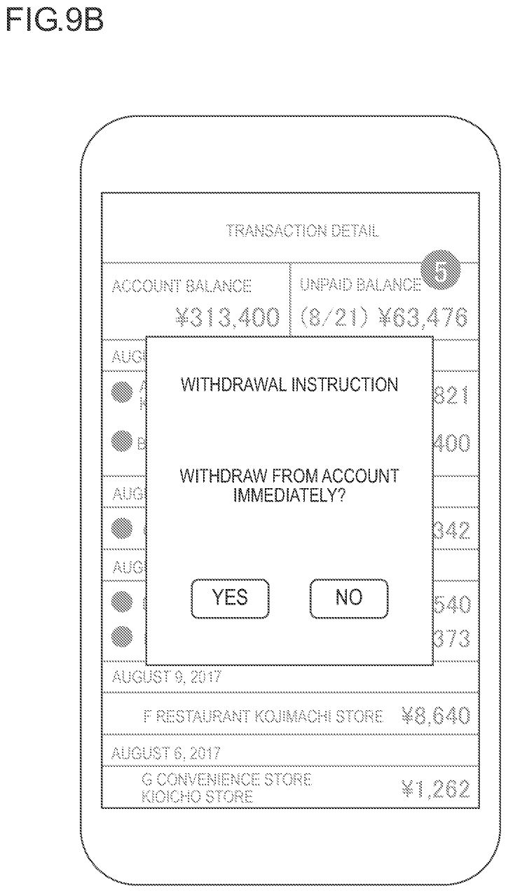

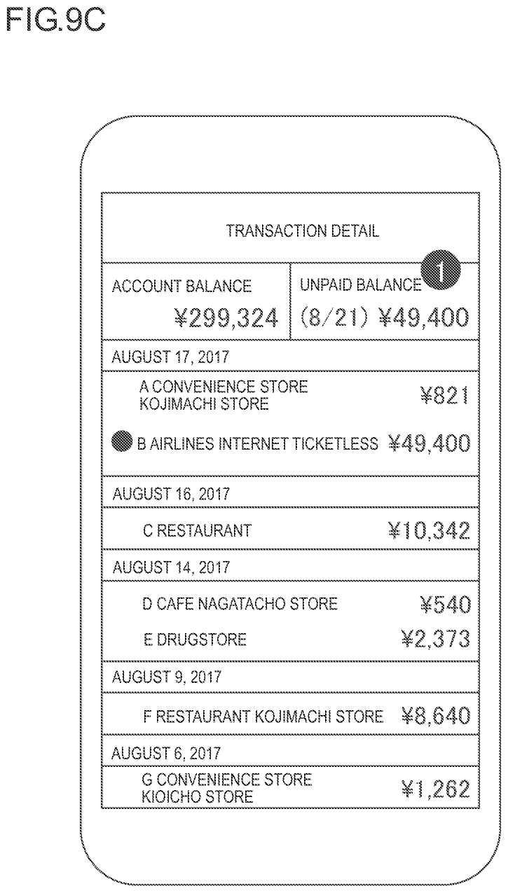

FIG. 8 is a sequence chart illustrating a procedure of the withdrawal process of the payment system. FIGS. 9A to 9C are diagrams illustrating examples of a display screen on the customer terminal. The withdrawal process illustrated in FIG. 8 is executed among the customer terminal 20, the server 30, and the financial institution system 40. That is, an algorithm of the withdrawal process illustrated in FIG. 8 is stored as a program in each storage unit of the customer terminal 20, the server 30, and the financial institution system 40, and is executed by each controller.

First, the customer terminal 20 receives a predetermined operation by the customer to display a transaction detail screen, which is a screen showing a transaction detail in the payment system 1, as illustrated in FIG. 9A, on the display unit 24 (step S201). For example, the customer terminal 20 may receive an operation of the customer for starting a dedicated application installed in the customer terminal 20 in advance to display a transaction detail screen associated with the application. Alternatively, the customer terminal 20 may display the transaction detail screen by receiving, for example, an operation of the customer for accessing a dedicated website via the customer terminal 20.

First, the transaction detail screen illustrated in FIG. 9A displays the balance of the savings account (account balance) of the customer at the financial institution where the financial institution system 40 is installed. Further, on the right side of the account balance, among transactions corresponding to the transaction information tanked in step S110 of FIG. 7, the total number of transactions for which payment is not completed (“5” in the example illustrated in FIG. 9A) and the total amount (unpaid balance) of the transactions are displayed. Further, a list of transactions corresponding to the tanked transaction information is displayed below the account balance and the unpaid balance. A transaction for which payment is not completed has a black circuit on the left side and is displayed separately from a transaction for which payment is completed.

Note that the customer terminal 20 may request that the server 30 transmit the tanked transaction information every predetermined period or each time an operation of the customer for displaying the transaction detail screen (for example, an operation of the customer for starting the dedicated application) is received. Further, the server 30 may transmit the tanked transaction information to the customer terminal 20 in response to a request from the customer terminal 20, and the customer terminal 20 may display the transaction detail screen based on the received transaction information.

Subsequently, the customer terminal 20 receives an operation of the customer for selecting at least one transaction on the transaction detail screen displayed in step S201 (step S202). Then, in the case of receiving an operation for selecting a transaction in step S202, the customer terminal 20 displays a withdrawal instruction screen for instructing the financial institution system 40 to perform withdrawal as illustrated in FIG. 9B on the display unit 24 (step S203). Alternatively, the customer terminal 20 may display the withdrawal instruction screen in the case of further receiving a predetermined operation by the customer after receiving the operation for selecting the transaction in step S202. Note that, when the total value of the transaction amounts in the transaction selected in step S202 exceeds the account balance, the customer terminal 20 may display a screen indicating that withdrawal is not allowed on the display unit 24.

Subsequently, the customer terminal 20 receives an operation of the customer for issuing an instruction to perform withdrawal on the withdrawal instruction screen displayed in step S203 (step S204). For example, on the withdrawal instruction screen illustrated in FIG. 9B, the customer terminal 20 receives an operation of the customer pressing a soft key “YES” as the operation of the customer for issuing the instruction to perform withdrawal. Then, in the case of receiving the operation for issuing the instruction to perform withdrawal in step S204, the customer terminal 20 transmits an instruction to withdraw the transaction amount in the transaction selected in step S202 to the server 30 (step S205).

Subsequently, the server 30 receives the withdrawal instruction transmitted in step S204 (step S206). Then, based on the withdrawal instruction received in step S206, server 30 instructs financial institution system 40 to withdraw the transaction amount in the selected transaction from the account of the customer (step S207). Specifically, first, the server 30 checks transaction information related to the transaction selected in step S202 in the transaction information tanked in step S110 of FIG. 7. Then, for example, the server 30 transmits the transaction information related to the selected transaction to the financial institution system 40 as payment information for each transaction. That is, the server 30 instructs the financial institution system 40 to withdraw the transaction amount from the account of the customer based on the customer account information and the amount information included in the transaction information. Further, the server 30 may instruct the financial institution system 40 to transfer the amount corresponding to the transaction amount to an account of the store based on the store information and the amount information included in the transaction information.

Subsequently, the financial institution system 40 withdraws the transaction amount from the account of the customer based on the instruction of the server 30 in step S207, and completes the payment (step S208). Then, the financial institution system 40 notifies the server 30 that the payment is completed (step S209).

Subsequently, based on the notification in step S209, the server 30 reflects a payment completion status in the transaction information related to the transaction for which payment is completed in the transaction information tanked in step S110 of FIG. 7 (step S210). Then, the server 30 notifies the customer terminal 20 that the payment is completed (step S211).

Subsequently, the customer terminal 20 displays a screen indicating completion of the withdrawal on the display unit 24 based on the notification in step S211 (step S212). Then, the payment system 1 ends the withdrawal process.

Here, a description will be given on the assumption that transactions other than “B Airlines Internet Ticketless” are selected among five transactions for which payment is not completed on the transaction detail screen illustrated in FIG. 9A, and a withdrawal is commanded on the withdrawal instruction screen illustrated in FIG. 9B. When the payment for the four transactions is completed, the server 30 reflects the payment completion status in transaction information related to the four transactions in step S210.

Thereafter, when the customer terminal 20 requests the server 30 to newly transmit the tanked transaction information, the server 30 transmits the transaction information reflecting the payment completion status in step S210 to the customer terminal 20. In this case, as illustrated in FIG. 9C, the customer terminal 20 displays the transaction detail screen in which the unpaid balance, the total number of transactions for which payment is not completed, and display of the black circle indicating the transaction are changed.

As described above, the server 30 as the payment control device in the payment system 1 determines whether or not to establish a transaction between the customer and the store based on the amount information and the customer account status. Then, in the case of determining to establish the transaction, the server 30 accumulates and stores transaction information related to the transaction to be established. Thereafter, the server 30 instructs the financial institution system 40 to withdraw the transaction amount from the account of customer based on the instruction of the customer. In this way, the server 30 can control the financial institution system 40 so as to withdraw the transaction amount at an arbitrary timing after the transaction desired by the customer, and it is possible to provide a payment method having high customer convenience.

Further, the server 30 accumulates transaction information related to the transaction to be established, and transmits the transaction information to the financial institution system 40 as payment information for each transaction based on an instruction of the customer. Therefore, the financial institution system 40 can provide a new payment service in which funds are withdrawn at a timing desired by the customer merely by performing a similar payment process to a conventional payment process without constructing a new mechanism. In this way, a financial institution such as a bank that installs the financial institution system 40 can rapidly and easily deploy a payment service having high customer convenience without developing a large-scale system which is inevitable when introducing a new payment service.

The server 30 instructs the financial institution system 40 to withdraw the transaction amount in the transaction information related to the transaction selected by the customer from the account of the customer. In this way, the server 30 can further control the financial institution system 40 so as to withdraw the transaction amount for each transaction desired by the customer, and can further improve customer convenience.

In addition, the server 30 notifies a transmission source of the transaction information of a result of determination as to whether or not to establish the transaction between the customer and the store. In this way, the server 30 can allow the customer and the store to check the determination result. When the server 30 determines to establish the transaction, the store can provide the customer with the product or the like and promptly complete the transaction at the store.

Further, the server 30 acquires the transaction information from the store terminal 10. When similar transaction information to that of normal debit payment can be acquired from the store terminal 10, the server 30 can determine whether or not to establish the transaction between the customer and the store without acquiring new information.

In addition, the server 30 checks, as the customer account status, a status of at least one of the balance of the savings account of the customer, the balance of the time deposit account, the overdraft limit of the overdraft or the like, and the available amount of the loan at the financial institution. The server 30 can check various statuses related to the account of the customer as the customer account status, and can determine whether or not to establish transaction between the customer and the store based on various conditions.

In addition, when the transaction amount is equal to or less than a predetermined amount, the server 30 determines to establish transaction between the customer and the store. When the transaction amount exceeds the predetermined amount, the server 30 determines not to establish the transaction. In this way, the server 30 can make an optimal determination as to whether or not to establish a transaction between the customer and the store based on the threshold.

In addition, conventionally, to perform a payment process such as withdrawal by connecting to a system of the financial institution such as the bank, it has been necessary to pass through a dedicated network referred to as a Value-Added Network (VAN), and appropriate cost has been required for each payment process. For this reason, as in the present embodiment, it is not realistic to withdraw money for each transaction, and no technical realization method has been proposed so far. However, with the recent spread of the Internet and the development of communication and security technologies, inexpensive and safe communication has become possible. Attempts have been made to provide a new connection method (interface) for enabling connection via the Internet even in the system of the financial institution. When the system of the financial institution is connected to the server 30 of the present embodiment via the Internet by utilizing such a new connection method, the financial institution can more easily implement a convenient payment service, and the customer can more conveniently make payments.

An example of processing of the payment system 1 has been described above. However, the present embodiment is not limited thereto. It is possible to make various modifications, improvements, and the like as described below.

It has been described that the store terminal 10 in the payment system 1 acquires the customer account information by reading the card owned by the customer using the card reading unit 17 in step S102. However, the present embodiment is not limited thereto. For example, the customer account information may be stored in the customer terminal 20 in advance, and the customer terminal 20 may be operated by the customer to display the customer account information on the display unit 24 in the form of a QR code or the like. Then, the store terminal 10 may acquire the customer account information by reading the QR code or the like displayed on the customer terminal 20 using the code reading unit 16. In this way, the customer can cause the store terminal 10 to acquire the customer account information without taking out and presenting the card, and the payment system 1 can further improve customer convenience.

In addition, the server 30 in the payment system 1 may collect, as payment information, transaction information for which payment is not completed in the tanked transaction information each time a predetermined period set in advance elapses and transmit the collected transaction information to the financial institution system 40, thereby completing the payment. That is, the server 30 may instruct the financial institution system 40 to automatically withdraw, from the account of the customer, the transaction amount in the transaction information for which withdrawal from the account of the customer is not completed in the tanked transaction information each time the predetermine period elapses. In this case, the server 30 may check with the customer whether the transaction amount for which withdrawal is not completed may be automatically withdrawn from the account of the customer before automatic withdrawal or via the customer terminal 20 in advance. In this way, the server 30 can avoid a situation in which transfer to the store is not performed for a long time without completion of payment, thereby causing a disadvantage to the store. Note that the predetermined period may correspond to, for example, one week or a period divided by a predetermined day of the week set in advance. In addition, the predetermined period may correspond to, for example, one month or a period divided by a predetermined date set in advance (for example, the last day of every month or the like). Furthermore, the predetermined period may correspond to a period set for each transaction, for example, a period starting from a date when the transaction information is tanked.

In addition, the server 30 may be able to receive an instruction of the customer to postpone withdrawal related to a specific transaction. Further, in the case of receiving an instruction of the customer to postpone the withdrawal, even when the predetermined period elapses, the server 30 need not to instruct the financial institution system 40 to withdraw the transaction amount in the transaction. In a case where the withdrawal is postponed, the server 30 may respond to an installment payment, a revolving payment, and the like based on an instruction of the customer. In addition, the server 30 may instruct the financial institution system 40 to calculate a fee to be charged to the customer based on a predetermined formula according to a prolonged period and withdraw the calculated fee from the account of the customer. In this way, the server 30 may further improve customer convenience and ensure the fee corresponding to postponement of the withdrawal.

Alternatively, the server 30 may receive a withdrawal instruction of the customer before a predetermined period elapses, and return a reward such as a predetermined point to the customer when the withdrawal is advanced. The server 30 may instruct the financial institution system 40 to calculate a reward returned to the customer based on a predetermined formula according to a period brought forward, and transfer the calculated reward to the account of the customer. In addition, there is a merit that when the withdrawal is advanced, the transfer to the store is advanced. For this reason, the server 30 may collect a commission from the store by instructing the financial institution system 40 to deduct a predetermined fee from the amount to be transferred to the store and transfer the same, for example.

### Second Embodiment

Hereinafter, a procedure of processing of the payment system 1 according to a second embodiment of the invention will be described. In the first embodiment, a mode in which the server 30 acquires the transaction information from the store terminal 10 has been described. However, a mode in which the server 30 acquires the transaction information is not limited thereto. In the second embodiment, a mode in which the server 30 acquires transaction information from the customer terminal 20 will be described. Note that since a withdrawal process according to the second embodiment is similar to that of the first embodiment, only a tanking process according to the second embodiment will be described below.

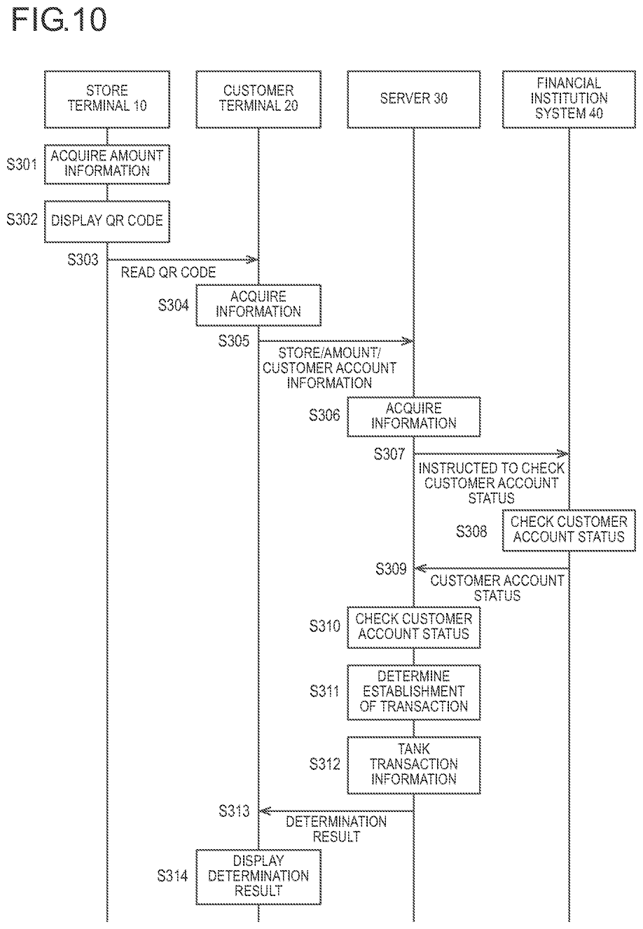

FIG. 10 is a sequence chart illustrating a procedure of a tanking process of a payment system according to the second embodiment. The tanking process illustrated in FIG. 10 is executed among the store terminal 10, the customer terminal 20, the server 30, and the financial institution system 40. That is, an algorithm of the tanking process illustrated in FIG. 10 is stored as a program in each storage unit of the store terminal 10, the customer terminal 20, the server 30, and the financial institution system 40, and is executed by each controller. Note that processing of steps S306 to S312 is similar to processing of steps S104 to S110 of FIG. 7, and thus a description thereof will be omitted.

First, the store terminal 10 is operated by a clerk or the like, thereby acquiring amount information of a product or the like intended to be purchased by the customer (step S301). Then, the store terminal 10 is operated by the clerk or the like to display store information and the amount information acquired in step S301 in the form of a QR code on the display unit 14 (step S302). When displaying the QR code, the store terminal 10 may further display a message prompting the customer terminal 20 to read the QR code on the display unit 14.

Upon being operated by the customer, the customer terminal 20 reads the QR code displayed in step S302 (step S303). For example, the customer terminal 20 reads the QR code by capturing the QR code using the code reading unit 26 and analyzing the captured QR code. Further, for example, the customer terminal 20 may read the QR code by executing a QR code reading function in a dedicated application installed in the customer terminal 20 in advance. Then, the customer terminal 20 extracts and acquires the store information and the amount information included in the QR code read in step S303 (step S304).

Subsequently, the customer terminal 20 transmits, to the server 30, transaction information including the store information and the amount information acquired in step S304 and customer account information stored in the customer terminal 20 in advance (step S305).

Subsequently, after processing of steps S306 to S312 is executed, the server 30 notifies the customer terminal 20 of a determination result in step S311 (step S313). Note that the server 30 may notify the store terminal 10 of the determination result in step S313. In addition, processing of steps S312 and S313 may be executed simultaneously, or may be executed in a changed order.

Subsequently, the customer terminal 20 displays the determination result notified in step S313 on the display unit 24 (step S314). Note that when the store terminal 10 is notified of the determination result in step S313, the store terminal 10 may display the determination result notified in step S313 on the display unit 14.

As described above, the server 30 according to the second embodiment acquires the transaction information from the customer terminal 20. In this way, even when the server 30 may not directly acquire the transaction information from the store terminal 10, the server 30 can provide a transaction method having high customer convenience by acquiring the transaction information from the customer terminal 20.

Further, the customer terminal 20 reads the QR code displayed on the store terminal 10 to acquire the store information and the amount information. In this way, the store information and the amount information can be easily acquired only by the store terminal 10 displaying the QR code and the customer terminal 20 reading the QR code.

Note that in the above description, the customer terminal 20 reads the QR code displayed on the store terminal 10 to acquire the store information and the amount information in step S304. However, the present embodiment is not limited thereto. The customer terminal 20 may acquire the store information and the amount information using another method. The customer terminal 20 may acquire the store information and the amount information from the store terminal 10 via short-range wireless communication such as NFC (Near Field Communication), for example.

Alternatively, the customer terminal 20 may acquire the store information and the amount information from other than the store terminal 10. For example, the customer terminal 20 may acquire the store information by reading a QR code indicating the store information presented at an arbitrary place in the store. Further, the customer terminal 20 may acquire the amount information, for example, by receiving an operation of the customer directly inputting the amount information.

In addition, processing in the payment system 1 according to the above-described embodiment may include a step other than the steps of the flowchart described above or may not include some of the steps. Further, the order of the steps is not limited to the above embodiments. Further, each step may be executed as one step in combination with another step, may be executed by being included in another step, or may be executed by being divided into a plurality of steps.

In addition, the means and method for performing various processes in each device of the payment system 1 according to the above-described embodiment can be realized by either a dedicated hardware circuit or a programmed computer. For example, the program may be provided by a computer-readable recording medium such as a CD-ROM (Compact Disc Read Only Memory), or may be provided online via a network such as the Internet. In this case, the program recorded on the computer-readable recording medium is normally transferred to and stored in a storage unit such as a hard disk. Further, the program may be provided as independent application software, or may be incorporated as one function of each device of the payment system 1 in software of the device.

### REFERENCE SIGNS LIST

1 PAYMENT SYSTEM
10 STORE TERMINAL
11, 21, 31, 41 CONTROLLER
12, 22, 32, 42 STORAGE UNIT
13, 23, 33, 43 COMMUNICATION UNIT
14, 24 DISPLAY UNIT
15, 25 OPERATION RECEIVING UNIT
16, 26 CODE READING UNIT
17 CARD READING UNIT
18, 27, 34, 44 BUS
20 CUSTOMER TERMINAL
30 SERVER
311 ACQUISITION UNIT
312 DETERMINATION UNIT
313 INSTRUCTION UNIT
314 NOTIFICATION UNIT
40 FINANCIAL INSTITUTION SYSTEM
50 NETWORK

1. A payment control device comprising:
an acquisition unit that acquires transaction information including store information corresponding to identification information of a store with which a customer performs a transaction, amount information corresponding to information about a transaction amount in the transaction, and customer account information corresponding to information about an account of the customer in a financial institution from a transmission source of the transaction information;
a determination unit that checks a customer account status which is a status of the account of the customer corresponding to the customer account information acquired by the acquisition unit, determines to establish the transaction between the customer and the store when the transaction amount is equal to or less than a predetermined amount calculated based on the customer account status, and determines not to establish the transaction when the transaction amount exceeds the predetermined amount;
a storage unit that accumulates and stores the transaction information related to the established transaction when it is determined to establish the transaction by the determination unit; and
an instruction unit that instructs a financial institution system corresponding to a system installed in the financial institution to withdraw the transaction amount indicated as the amount information in the transaction information accumulated in the storage unit from the account of the customer based on an instruction of the customer.

2. The payment control device according to claim 1, wherein the instruction unit instructs the financial institution system to withdraw the transaction amount in the transaction information related to the transaction selected by the customer in the transaction information accumulated in the storage unit from the account of the customer.

3. The payment control device according to claim 1, further comprising a notification unit that notifies the transmission source of a determination result by the determination unit.

4. The payment control device according to claim 1,
wherein the transmission source is a store terminal corresponding to a terminal installed in the store, and
the acquisition unit acquires, from the store terminal, the transaction information including the store information corresponding to the identification information of the store where the store terminal is installed and the amount information and the customer account information acquired by the store terminal.

5. The payment control device according to claim 1,
wherein the transmission source is a customer terminal corresponding to a terminal owned by the customer, and
the acquisition unit acquires, from the customer terminal, the transaction information including the store information and the amount information acquired by the customer terminal and the customer account information stored in the customer terminal.

6. The payment control device according to claim 5, wherein the acquisition unit acquires the store information and the amount information acquired by the customer terminal by reading a QR code displayed on a store terminal corresponding to a terminal installed in the store.

7. The payment control device according to o claim 1, wherein the determination unit checks, as the customer account status, a status of at least one of a balance of a savings account of the customer, a balance of a time deposit account, an overdraft limit, and an available amount of a loan at the financial institution.

8. The payment control device according to claim 1, wherein the instruction unit instructs the financial institution system to withdraw the transaction amount in the transaction information for which withdrawal from the account of the customer is not completed in the transaction information accumulated in the storage unit from the account of the customer each time a predetermined period elapses.

9. The payment control device according to claim 1, wherein when there is an instruction of the customer to postpone withdrawal, the instruction unit instructs the financial institution system to withdraw a fee calculated according to a prolonged period from the account of the customer.

10. A payment system comprising:
the payment control device according to claim 1;
a store terminal corresponding to a terminal installed in the store;
a customer terminal corresponding to a terminal owned by the customer; and
the financial institution system corresponding to a system installed in the financial institution.

11. A control program of a payment control device that controls a payment between a customer and a store, the control program for causing a computer to execute processing including:
an acquisition step of acquiring transaction information including store information corresponding to identification information of the store with which the customer performs a transaction, amount information corresponding to information about a transaction amount in the transaction, and customer account information corresponding to information about an account of the customer in a financial institution from a transmission source of the transaction information;
a determination step of checking a customer account status which is a status of the account of the customer corresponding to the customer account information acquired in the acquisition step, determining to establish the transaction between the customer and the store when the transaction amount is equal to or less than a predetermined amount calculated based on the customer account status, and determining not to establish the transaction when the transaction amount exceeds the predetermined amount;
a storage step of accumulating and storing the transaction information related to the established transaction when it is determined to establish the transaction in the determination step; and
an instruction step of instructing a financial institution system corresponding to a system installed in the financial institution to withdraw the transaction amount indicated as the amount information in the transaction information accumulated in the storage step from the account of the customer based on an instruction of the customer.
